(19) United States
(12) Patent Application Publication
(10) Pub. No.: US 2014/0351124 A1
(43) Pub. Date: Nov. 27, 2014

(54) SELF-SERVICE BANKING SYSTEM

(71) Applicant: OKI BRASIL INDÚSTRIA E COMÉRCIO DE PRODUTOS E TECNOLOGIA EM AUTOMAÇÃO S.A., Sao Paulo (BR)

(72) Inventors: MILTON SHIZUO NOGUCHI, Sao Paulo (BR); CARLOS YOSHIHARU YAMAGATA, Sao Paulo (BR); JULIO RAMOS REY FERNANDEZ, Sao Paulo (BR)

(21) Appl. No.: 14/280,275

(22) Filed: May 16, 2014

(30) Foreign Application Priority Data
May 21, 2013 (BR) 10 2013 012549 0

(51) Int. Cl. G06Q 20/10

(52) U.S. Cl. CPC G06Q 20/1085; G06Q 40/02
USPC 705/43

(57) ABSTRACT

The present invention relates to a self-service banking system, comprising: one or more means for depositing or withdrawing sums (2); one or more sums storage means (3) disposed spaced apart from said one or more means for depositing or withdrawing sums (2); and at least one means of transportation (4) configured for transporting sums between the one or more means for depositing or withdrawing sums (2) and the one or more sums storage means (3).

### FIELD OF INVENTION

The present invention relates to a self-service banking system.

### BACKGROUND OF THE INVENTION

The self-service banking electronic terminals or cash machines, also known as ATM (“Automated Teller Machine”), are devices that allow the access of clients of a financial institution to determined services offered by it. In other words, clients of financial institutions can perform several banking operations and transactions such as, for example, withdrawals, consultations, payments, transfers and investments through the self-service terminals. In this sense, avoiding lines at personal/face-to-face attendance represents great convenience, agility and time saving. On the other hand, financial institutions also benefit from ATMs, since the customer attendance costs are significantly reduced due to the automation of services, dispensing the creation of new bank agencies, in addition to reducing the costs for hiring and managing employees.

Presently, it is possible to verify that the self-service banking terminals are installed in several commercial points, such as malls, supermarkets, convenience stores, shopping galleries etc., such that there is great availability and ease of access to financial institutions services in a wide variety of locations.

Additionally, along with the growing popularity and presence of self-service banking terminals, there is also a raise in the occurrence of criminal cases, leading to a higher security risk in such terminals. In this context, it is noteworthy that the area in which the ATMs are presently installed, namely, in the lobby of the bank agency, is less protected compared to the interior of the agency, which makes its violation easier through fraudulent actions and vandalism attacks by criminals out of the agency operation hours, as in the evening/night periods and weekends, since in such periods there is usually less movement in the cash machines and there is no human security in the locations where they are installed.

Moreover, presently known ATMs are easy targets for criminals, due to the construction configuration they present. To exemplify such construction configuration, reference is made to FIG. 1, which illustrates a state of the art self-service banking terminal (or ATM). The state of the art ATMs are built generally by a body provided with user interface equipment 14 in the upper portion and a sums storage 15 in the lower portion, such storage 15 being provided with a nozzle 16 for the withdrawal de sums. The storage 15 can be a safe or, yet, a dispenser encompassed in a safe, as those skilled in the art know. Therefore, the fact that the user interface equipment 14 is placed with the sums storage 15 and exposed to public places make the sums easily accessible by criminals who manage to violate the safe or the safety device protecting the integrity of the storage 15. In daily situations, criminals have managed to violate ATMs' safes using explosive materials 17, which are inserted in the outlet nozzle for sums 16. Once the storage device protection 15 is violated, criminals retrieve the sums contained therewith, causing huge losses.

Therefore, it is evident that the state of the art lacks a self-service banking system that overcomes these and other problems caused by criminal actions.

Therefore, in order to solve the above-exemplified problems existent in the state of the art, the present invention aims at, among others, providing a self-service banking system comprising one or more means for depositing or withdrawing sums spaced apart from one or more sums storage means.

Another object of the present invention is providing at least one means of transportation configured to transport sums between the one or more means for depositing or withdrawing sums and the one or more sums storage means.

The present invention, through its own features, can additionally solve other problems of the state of the art that have not been presented as examples herein, since the list discussed in the present document of systems and self-service banking equipment and their problems is exemplificative, but not exhaustive.

### DESCRIPTION OF THE INVENTION

To overcome the above-mentioned inconveniences of state of the art, among others, the present invention relates to a self-service banking system comprising: one or more means for depositing or withdrawing sums; one or more sums storage means placed spaced apart from said one or more means for depositing or withdrawing sums; and at least one means of transportation configured to transport sums between the one or more means for depositing or withdrawing sums and the one or more sums storage means.

According to additional or alternative embodiments of the present invention, the following features and its possible variants can also be present, alone or combined:
The one or more means for depositing or withdrawing sums comprise a user interface through which a user is capable of performing banking transactions of withdrawal or deposit of sums.
The means for depositing or withdrawing sums comprise one or more openings for a user to withdrawal or deposit sums.
Said one or more means for depositing or withdrawing sums is a self-service terminal (ATM).
The sums storage means comprise one or more sums dispenser units and one or more safes.
Each sums dispenser unit is placed inside a respective safe.
More than one sums dispenser unit are placed inside the same safe.
The one or more sums storage means is additionally placed in a different environment from the one or more means for depositing or withdrawing sums.
The segregation of the different environments in which are placed the one or more sums storage means and the one or more means for depositing or withdrawing sums is performed by at least one physical barrier, the transportation means being configured, additionally, for transporting the at least one physical barrier in at least one stretch.
The means of transportation is configured to transport sums: between one or more means for depositing or withdrawing sums and more than one medium for storing sums; between more than one medium for depositing or withdrawing sums and a medium for storing sums; or between more than one medium for depositing or withdrawing sums and more than one medium for storing sums.
The means of transportation comprise a transportation guide and a sums mobile carrier that shifts through the transportation guide, the transportation guide being placed as to interconnect the one or more means for depositing or withdrawing sums to the one or more sums storage means.
The transportation guide is configured to cross at least a stretch of the physical barrier.
The sums mobile carrier comprises a sums accommodation device configured to receive the sums while the mobile carrier transports them.
The sums accommodation device is capable of shifting towards the one or more means for depositing or withdrawing sums or to the one or more sums storage means to receive and deliver sums to be carried while the sums mobile carrier transports them.
The sums mobile carrier comprises a shifting system capable of propelling it through the transportation guide.

### BRIEF DESCRIPTION OF THE DRAWINGS

The objects, functional upgrading and advantages of the self-service banking system, object of the present invention, are apparent to the person skilled in the art from the following description relative to a particular embodiment, which makes reference to the attached figures. The figures are schematic, and their dimensions and proportions may not correspond to reality, since they only serve the purpose of didactically describing the invention, without imposing any limitations in addition to those defined in the claims further ahead, wherein:

FIG. 1 is a schematic representation of a self-service machine (ATM) from the state of the art;

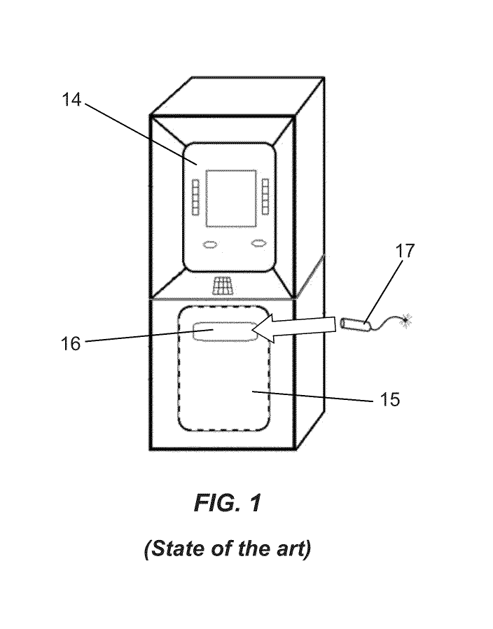

FIG. 2 is a block diagram of a particular embodiment of the self-service system of the present invention;

FIG. 3 is a schematic view of a particular embodiment of the means of transportation of the self-service banking system of the present invention.

### DESCRIPTION OF THE EMBODIMENTS OF THE INVENTION

The invention will now be described relating to its particular embodiments, with reference to the attached figures. In the figures and in the following description, similar parts are marked throughout the specification and the figures with equal reference numbers. The figures are not, necessarily, in scale. Determined features can be shown with scaling exaggeration or schematically, and some details of conventional elements may not be represented, for the sake of greater clarity and concision of the present description. The invention is susceptible to different forms of embodiments. Specific embodiments are described in details and shown in the figures, with the understanding that they must be considered as an exemplification of their principles, and is not intended to limit the invention only to what is illustrated and described in the present specification. It is recognized that the different teachings of the embodiments discussed below can be employed separately or in any suitable combination to produce the same desired results.

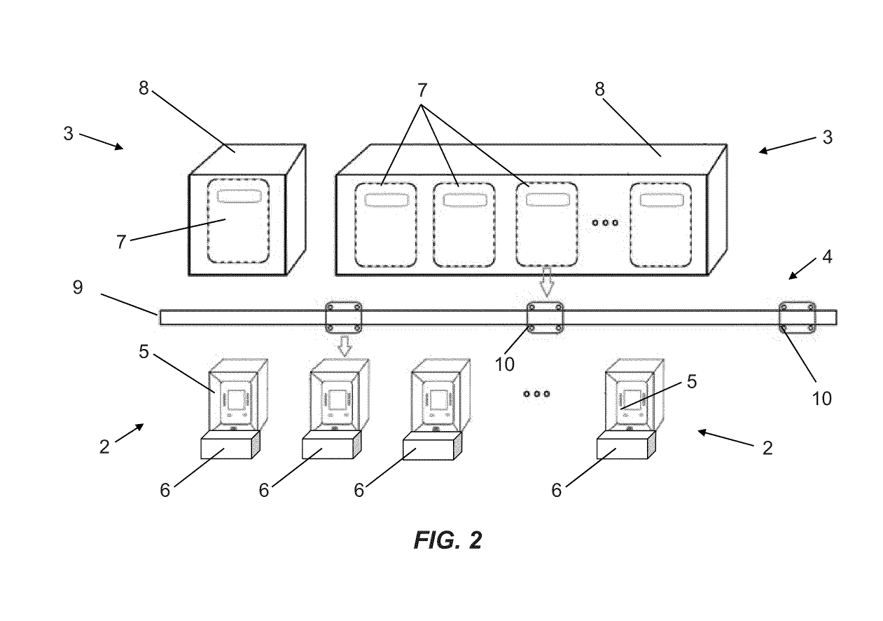

As can be seen from FIG. 2, the self-service banking system 1 of the present invention comprises one or more means for depositing or withdrawing sums 2, one or more sums storage means 3 and at least one means of transportation 4.

The one or more means for depositing or withdrawing sums 2 comprises, for example, a user interface 5 and one or more openings 6 for withdrawal or deposit de sums by a user. Through the user interface 5, a client can perform banking operations and transactions, such as, for example, withdrawals, consultations, payments, transfers, deposits on current account and investments, the sums being withdrawn or deposited through the nozzle 6.

The “sums” deposited or withdrawn through system 1 of the present invention can refer to any object representing a monetary value, such as, for example, bank notes (for example, paper money), credit instruments (for example, checks), among others applicable to the present invention.

Concerning the amount and disposition of the one or more means for depositing or withdrawing sums 2, reference is made again to FIG. 2. In the embodiment illustrated in this figure, system 1 of the present invention comprises more than one medium for depositing or withdrawing sums 2, each comprising, in quantity, a user interface 5 and a nozzle 6. However, in alternative embodiments, the invention can comprise only one medium for depositing or withdrawing sums 2, provided with a user interface 5 and two openings 6, one being destined for withdrawing and the other one for depositing sums, for example. Therefore, as can be noted, the amount of the means for depositing or withdrawing sums 2, their user interfaces 5 and openings 6 can vary depending on the embodiment of the present invention.

In a particular embodiment of the present invention, the one or more means for depositing or withdrawing sums 2 are self-service banking terminals, known as ATMs.

With further reference to FIG. 2, system 1 of the present invention also comprises, as has already been mentioned, one or more sums storage means 3. Such one or more sums storage means 3 comprise, further, one or more units for dispensing or accepting sums 7 and one or more safes 8.

Among several possibilities, FIG. 2 illustrates two embodiments for the sums storage means 3. In a first form, a unit for dispensing or accepting sums 7 is placed within a respective safe 8, that is, there is a safe 8 for a single unit for dispensing or accepting sums 7. On the other hand, in a second form, more than one unit for dispensing or accepting sums 7 are placed inside the same safe 8, that is, such dispensing or accepting units 7 share the same safe 8.

Other embodiment possibilities can derive from these two. For example, system 1 of the present invention can have one or more sums storage means 3, each comprising a safe 8 with a unit for dispensing or accepting sums 7 therein. Alternatively, system 1 of the present invention may be used as to contain several safes 8, each containing more than one unit for dispensing or accepting sums 7 therein.

Additionally, the present invention can be further carried out as to contain a combination of the first form and the second form of performing the medium for storing sums 3, such as shown in FIG. 2.

In system 1 of the present invention the one or more sums storage means 3 are placed spaced apart from the one or more means for depositing or withdrawing sums 2. Thus, contrary to the state of the art, the one or more means for depositing or withdrawing sums 2 and the one or more sums storage means 3 are not placed adjacent to one another.

In a particular embodiment of the present invention, besides being spaced apart, the one or more sums storage means 3 is placed in a different environment from the one or more means for depositing or withdrawing sums 2. Therefore, for example, the one or more means for depositing or withdrawing sums 2 can be in an environment that is accessible by the public, while the one or more sums storage means 3 can be in a different environment, which can be internal, closed, distant, among other possibilities within the scope of the present invention. Particularly, one of the embodiments of the present invention provides for such environments to be separated through at least one physical barrier, such as a concrete, glass and iron wall, among other possible ones. However, this physical barrier does not necessarily close a room from ceiling to floor, such that it may be similar to a simpler partition, lower and thinner compared to a conventional concrete wall.

For it to be possible to transport sums between one or more means for depositing or withdrawing sums 2 and one or more sums storage means 3, the system of the present invention further comprises at least one means of transportation 4. In view that the present invention can be carried out with various amounts of means for depositing or withdrawing sums 2 and of sums storage means 3, the at least one means of transportation 4 can be configured to transport sums between: (i) one or more means for depositing or withdrawing sums 2 and more than one medium for storing sums 3; (ii) more than one medium for depositing or withdrawing sums 2 and one medium for storing sums 3; or (iii) more than one medium for depositing or withdrawing sums 2 and more than one medium for storing sums 3. In this sense, in the particular embodiment of system 1, according to which there is at least one physical barrier separating the one or more means for depositing or withdrawing sums 2 and the one or more sums storage means 3, the at least one means of transportation 4 is configured to transport at least one physical barrier in at least one stretch, as to secure the sums transportation even through separate environments.

In the embodiment illustrated in FIG. 2, the at least one means of transportation 4 comprises a transportation guide 9 placed as to interconnect one or more means for depositing or withdrawing sums 2 to one or more sums storage means 3. The means of transportation 4 comprises, as well, a sums mobile carrier 10, which shifts through the transportation guide 9. In the embodiment of the invention wherein system 1 comprises at least one physical barrier, the transportation guide 9 is configured to go through such barrier in order to, thus, make the sums transportation possible between the different environments.

Additionally, it is necessary to highlight that the means of transportation 4 can comprise one or more transportation guides 9 and one or more sums mobile carriers 10, such that the amount of such components does not limit the scope of protection of the present invention. Complementarily, in alternative embodiments of the invention, the system 1 can comprise more than one means of transportation 4, each provided with one or more transportation guides 9 and one or more sums mobile carriers 10. Such different transportation means 4 can connect “blocks” or groups of means for depositing or withdrawing sums 2 and of sums storage means 3.

This way, considering that the at least one means of transportation 4 can interconnect a plurality of sums storage means 3 to a plurality of means for depositing or withdrawing sums 2, system 1 of the present invention also acquires flexibility in its operation. For example, in case there is unavailability of one or more sums storage means 3 due to a defect, the sums transportation can be conducted through the access of the transportation means 4 to other available sums storage means 3. The same can happen when, for example, a sums storage means 3 runs out of paper money, such that the at least one means of transportation 4 can access other sums storage means 3 with available paper money.

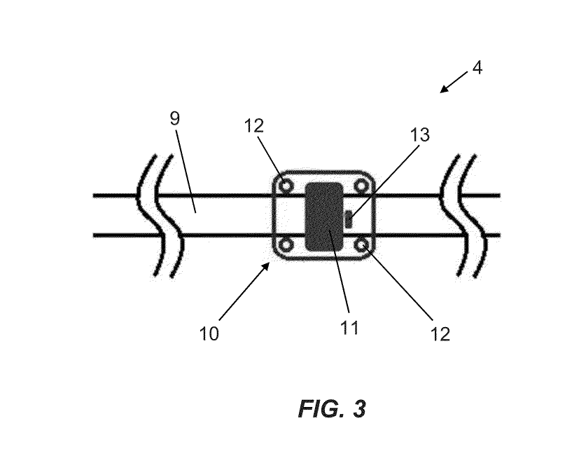

Now, with reference to FIG. 3, the sums mobile carrier 10 comprises a sums accommodation device 11 configured to receive the sums while the mobile carrier 10 transports them. Such sums accommodation device 11 is further capable of shifting itself towards the one or more means for depositing or withdrawing sums 2 or to the one or more sums storage means 3. Therefore, it is possible to receive and deliver sums to be carried while the sums mobile carrier 10 transports them.

To shift through the transportation guide 9, the sums mobile carrier 10 also comprises a shifting system 12 capable of propelling it.

This way, from system 1 of the present invention, there is a substantial increase in the safety of the transitioned sums in banking transactions. This can also be noticed through a brief description of the operation of system 1 that follows.

As mentioned above, in an embodiment of the present invention according to which the one or more means for depositing or withdrawing sums 2 is a self-service terminal ATM. In this embodiment, it is also taken into consideration that the ATM comprises a user interface 5 and one or more openings 6 for withdrawing or depositing sums. Therefore, a bank client wishing to, for example, withdraw money through the ATM, performs the steps displayed in the user interface 5, such as, for example, inserting the bank card, inserting passwords, among others. From the moment in which the ATM is instructed to make available an amount in money in the nozzle 6, the sums mobile carrier 10 is actuated to fetch a certain amount of paper money in one or more units for dispensing or accepting sums 7. Therefore, in the recited example, the sums mobile carrier 10 heads for a unit for dispensing or accepting sums 7 and uses its sums accommodation device 11 to retrieve the paper money, since this device 11 is capable of shifting towards the unit for dispensing or accepting sums 7. Once the sums are retrieved from the dispensing or accepting unit 7, the sums mobile carrier 10 shifts towards the ATM from where the command of banking withdrawal was originated, so that, then, it can make the paper money available at the nozzle for withdrawing or depositing sums 6, wherein the sums accommodation device is also capable of shifting towards the nozzle 6.

Further, in the path between the ATM and the dispensing or accepting unit 7, the sums mobile carrier 10 can go through one or more cavities of one or more walls separating the different environments in which one or more ATMs and the one or more sums dispensing or accepting units 7 are located.

As can be noted, the present invention completely reaches its objects, since it proposes a self-service banking system 1 comprising one or more means for depositing or withdrawing sums spaced apart from one or more sums storage means, making the violation of safes and similar more difficult for criminals who use explosives to violate the safes that were placed right under the user interface in an ATM.

Although the self-service banking system of the present invention is particularly useful for performing banking transactions, the system of the present invention can be construed for other types of applications and can present modifications in the way it is implemented, such that the scope of protection of the invention is only limited by the content of the attached claims, including possible equivalent variations.

1. SELF-SERVICE BANKING SYSTEM, comprising:
one or more means for depositing or withdrawing sums; and
one or more sums storage means;
wherein said one or more sums storage means is disposed spaced from said one or more means for depositing or withdrawing sums;
and wherein at least one means of transportation is configured to transport sums between the one or more means for depositing or withdrawing sums and the one or more sums storage means.

2. The system according to claim 1, characterized in that wherein said one or more means for depositing or withdrawing sums comprises a user interface through which a user is capable of performing banking transactions of withdrawal or deposit of sums.

3. The system according to claim 2, wherein said one or more means for depositing or withdrawing sums comprises one or more nozzles for the withdrawal or deposit of sums by a user.

4. The system according to any of the claim 1, wherein said one or more means for depositing or withdrawing sums is a self-service terminal (ATM).

5. The system according to claim 1, wherein said one or more sums storage means comprises one or more units for dispensing or accepting sums and one or more safes.

6. The system according to claim 5, wherein each unit for dispensing or accepting sums is placed inside a respective safe.

7. The system according to claim 5, wherein more than one unit for dispensing or accepting sums are placed inside the same safe.

8. The system according to claim 1, wherein said one or more sums storage means is placed in a different environment from said one or more means for depositing or withdrawing sums.

9. The system according to any of the claim 1, wherein said different environment in which said one or more sums storage means and said one or more means for depositing or withdrawing sums is placed is formed by at least one physical barrier, wherein, additionally, the transportation means are configured to pass the at least one physical barrier in at least one portion of the physical barrier.

10. The system according to claim 1, wherein said means of transportation is configured to transport sums: between said one or more means for depositing or withdrawing sums and more than one medium for storing sums; between more than one medium for depositing or withdrawing sums and a medium for storing sums; or between more than one medium for depositing or withdrawing sums and more than one medium for storing sums.

11. The system according to claim 1, wherein said means of transportation comprises a transportation guide and a sums mobile carrier that shifts through the transportation guide, wherein the transportation guide is placed as to interconnect said one or more means for depositing or withdrawing sums and said one or more sums storage means.

12. The system according to claim 9, wherein that the transportation guide is configured to cross the at least one portion of the physical barrier.

13. The system according to claim 11, wherein the sums mobile carrier comprises a sums accommodation device configured for receiving the sums while they are transported by the mobile carrier.

14. The system according to claim 13, wherein the sums accommodation device is capable of shifting towards the one or more means for depositing or withdrawing sums or to the one or more sums storage means for receiving and delivering sums to be carried while they are transported by the sums mobile carrier.

15. The system according to claim 11, wherein the sums mobile carrier comprises a shifting system capable of propelling it through the transportation guide.
